(19) United States
(12) Patent Application Publication
(10) Pub. No.: US 2009/0320060 A1
(43) Pub. Date: Dec. 24, 2009

(54) ADVERTISEMENT SIGNATURE TRACKING

(75) Inventor: Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,826

(22) Filed: Jun. 23, 2008

(51) Int. Cl. H04N 7/10

(52) U.S. Cl. 725/32

(57) ABSTRACT

Advertisement signature tracking is described. In embodiment(s), a video feed of television media content can be received for distribution to media devices, and the video feed can include advertisements. An advertisement can be detected in the video feed of the television media content, and a signature of the advertisement can be generated. Occurrences of the advertisement can then be detected and tracked by the signature of the advertisement when the advertisement is subsequently received via the video feed and/or broadcast for viewing.

### BACKGROUND

Typically, national video feeds are received for various television channels, and local or regional advertisements can then be inserted into the television channels that are broadcast to subscribers of a television service. Additionally, national advertisements that are included in the national video feeds can be replaced with local or region specific advertisements for local advertising to viewers of a particular region. The local advertisements for products and services are typically a primary source of revenue for a content distributor that receives and distributes the national video feeds of television channels. Advertisers want to know how many local or regional advertisements are included or inserted into the national video feeds for the various television channels when they are broadcast to subscribers.

### SUMMARY

This summary is provided to introduce simplified concepts of advertisement signature tracking. The simplified concepts are further described below in the Detailed Description. This summary is not intended to identify essential features of the claimed subject matter, nor is it intended for use in determining the scope of the claimed subject matter.

Advertisement signature tracking is described. In embodiment(s), a video feed of television media content can be received for distribution to media devices, and the video feed can include advertisements. An advertisement can be detected in the video feed of the television media content, and a signature of the advertisement can be generated. Occurrences of the advertisement can then be detected and tracked by the signature of the advertisement when the advertisement is subsequently received via the video feed and/or broadcast for viewing.

In other embodiment(s), an image representation of the advertisement can be determined that represents a product or service advertised in the advertisement. The image representation of the advertisement can include an image of the product shown in the advertisement and/or can include a text label of the product shown in the advertisement. In one embodiment, the signature of an advertisement can be generated based on the image representation of the advertisement.

### BRIEF DESCRIPTION OF THE DRAWINGS

Embodiments of advertisement signature tracking are described with reference to the following drawings. The same numbers are used throughout the drawings to reference like features and components:

FIG. 1 illustrates an example system in which embodiments of advertisement signature tracking can be implemented.

FIG. 2 illustrates example method(s) for advertisement signature tracking in accordance with one or more embodiments.

FIG. 3 illustrates various components of an example device which can implement embodiments of advertisement signature tracking.

### DETAILED DESCRIPTION

Embodiments of advertisement signature tracking provide that advertisements can be detected or determined by unique signatures for each of the advertisements. Subsequent occurrences of the advertisements can be compared against a data set of advertisement signatures and tracked to compile distribution data corresponding to the advertisements. The distribution data can then be utilized by advertisers to audit the advertisements that have been paid for distribution, and also to determine the mix of national and local advertisement inventories to negotiate advertising rates.

While features and concepts of the described systems and methods for advertisement signature tracking can be implemented in any number of different environments, systems, and/or various configurations, embodiments of advertisement signature tracking are described in the context of the following example systems and environments.

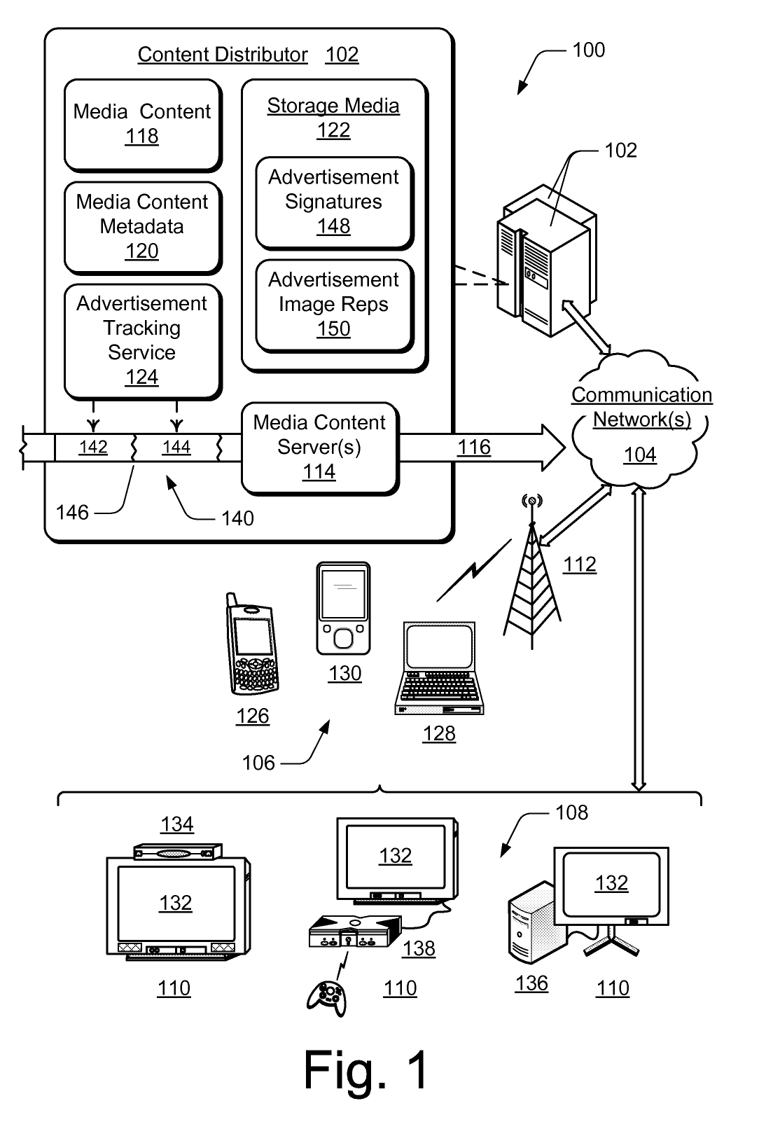

FIG. 1 illustrates an example system 100 in which various embodiments of advertisement signature tracking can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, viewing systems, and devices.

The communication network(s) 104 can be implemented to include any type of data network, voice network, broadcast network, an IP-based network, a wide area network (e.g., the Internet), and/or a wireless network 112 that facilitates media content distribution and data communication between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way data communication, such as from the content distributor 102 to a media device 108 (e.g., a client device) and vice-versa.

The content distributor 102 can include media content servers 114 that are implemented to receive video feeds 116 of television media content for distribution to media devices. The content distributor 102 can receive the video feeds 116 of television media content from various content sources, such as national television providers that distribute a national video feed of television media content to a local affiliate that picks up the video feed for broadcast or other distribution, such as to content distributor 102 that then distributes the television media content to the subscriber media devices. The content distributor 102 can communicate or otherwise distribute media content 118 (e.g., to include the television media content) and/or other data to any number of the various wireless media devices 106 and other media devices 108.

The media content 118 (e.g., to include recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, advertising content, closed captions data, content metadata, search results and/or recommendations, and the like).

Other media content can include media content metadata 120 that includes identifying criteria, descriptive information, and/or attributes associated with the media content 118 that can describe and categorize the media content. The metadata 120 associated with a television program, movie, or advertisement can be any form of information that describes and/or characterizes the media content. For example, metadata can include a program or movie identifier, a title, a subject description of the program, movie, or advertisement, a plot description, actor information, a date of production, broadcast channel, television network, artistic information, music compilations, and any other possible descriptive information about the media content. Further, metadata can characterize a genre that describes the media content as being an advertisement, a movie, a comedy show, a sporting event, a news program, a sitcom, a talk show, an action/adventure program, or as any number of other category descriptions.

In the example system 100, the content distributor 102 includes storage media 122 to store or otherwise maintain various data and media content, such as media content 118 and media content metadata 120. In a Network Digital Video Recording (nDVR) implementation, recorded on-demand assets can be recorded when initially distributed to the various media devices as scheduled television media content (e.g., from the video feed 116 of television media content), and stored with the storage media 122 or other suitable storage device. The storage media 122 can be implemented as any type of memory, random access memory (RAM), read only memory (ROM), any type of magnetic or optical disk storage, and/or other suitable electronic data storage.

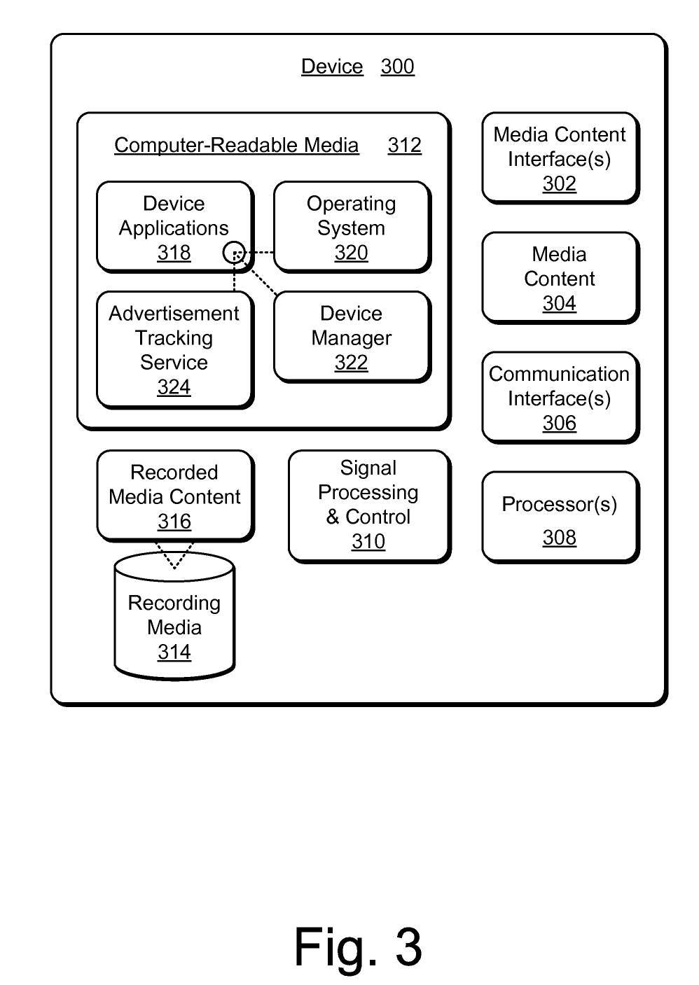

Content distributor 102 also includes an advertisement tracking service 124 that can be implemented as computer-executable instructions and executed by processor(s) to implement various embodiments and/or features of advertisement signature tracking. In addition, a content distributor 102 can be implemented with any number and combination of differing components as further described with reference to the example device shown in FIG. 3. Although illustrated and described as a component or module of the content distributor 102, the advertisement tracking service 124, as well as other functionality described to implement embodiments of advertisement signature tracking, can also be provided as a service apart from the content distributor 102 (e.g., on a separate server or by a third party service).

The wireless media devices 106 can include any type of device implemented to receive and/or communicate wireless data, such as any one or combination of a mobile phone device 126 (e.g., cellular, VoIP, WiFi, etc.), a portable computer device 128, a media device 130 (e.g., a personal media player, portable media player, etc.), and/or any other wireless media device that can receive media content in any form of audio, video, and/or image data. Each of the client systems 110 include a respective client device and display device 132 that together render or playback any form of audio, video, and/or image content, media content, and/or television content.

A display device 132 can be implemented as any type of a television, high definition television (HDTV), LCD, or similar display system. A client device in a client system 110 can be implemented as any one or combination of a television client device 134 (e.g., a television set-top box, a digital video recorder (DVR), etc.), a computer device 136, a gaming system 138, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, and a media content rendering system. A media device may also be associated with a user or viewer (i.e., a person) and/or an entity that operates the device such that a media or client device describes logical devices that include users, software, and/or a combination of devices.

The media content servers 114 at content distributor 102 can receive the video feed 116 of television media content 118 that includes national advertisements and spliced-in local advertisements. A video feed 116, or video stream, can include multiple segments of television programming (for one or more television programs) interspersed or separated by multiple advertisement pods, each having one or more advertisements or commercials for various products and/or services. In this example, the video feed 116 includes an advertisement pod 140 that includes advertisements 142 and 144. Advertisement 142 is shown as a advertisement that was originally distributed with the video feed 116, such as a national advertisement. Advertisement 144 is shown as an advertisement that has been spliced into the video feed 116 at a splice point generally identified at 146.

In one or more embodiments, the advertisement tracking service 124 at content distributor 102 can be implemented to detect an advertisement 142 and/or 144 in the video feed 116 of the television media content. In various embodiments, the advertisement tracking service 124 can detect an advertisement by various techniques, such as determining the boundaries of an advertisement (e.g., a beginning and/or an end of an advertisement), by detecting a splice point in a video feed or video stream that indicates where an advertisement has been spliced into the video stream, and the like.

In various embodiments, the advertisement tracking service 124 can be implemented to detect an advertisement or determine the boundaries of an advertisement by various techniques that include, but is not limited to, detecting black video frames on either side of an advertisement in a video stream; detecting an increased audio level in the video stream which may indicate an advertisement; detecting no audio which may indicate a transition from television programming or other video content to an advertisement; detecting a change in the aspect ratio, such as a change from high definition to standard definition; and/or by monitoring closed captions data to detect an advertisement.

In other embodiments, the advertisement tracking service 124 can detect a splice point in a video stream that indicates where an advertisement has been spliced into the video stream. The advertisement tracking service 124 can be implemented to detect a splice point, such as in an MPEG transport stream, by various techniques. In an embodiment, the advertisement tracking service 124 can detect a splice point 146 in the video feed 116 of the television media content as a forced quantization match of video of an advertisement 144 that has been inserted into the video feed. A forced quantization match can occur at splice point 146 when advertisement insertion equipment forces a quantization match of the video of the inserted advertisement to the buffered video of the video feed (e.g., matches the buffer model of the video feed). At or near the beginning of an inserted advertisement, scene changes from the video feed to the inserted advertisement can correlate to a change in the video rate which is forced to match the video rate of the video feed. Typically, the quantization can initially be at its highest (e.g., having a higher Q-factor) at the insertion or splice point 146 of the inserted advertisement into the video feed 116.

In another embodiment, the advertisement tracking service 124 can detect a splice point 146 in the video feed 116 as a video frame pattern change from the video feed to video of an advertisement 144 that has been inserted into the video feed. In an MPEG video stream, for example, a change in the I-frame, P-frame, and/or B-frame pattern or cadence can indicate a splice point 146. For example, the video feed 116 may have a combination of ordered I-frames and P-frames intermixed with B-frames, whereas an inserted advertisement may only have a combination of I-frames and P-frames. A change from a frame pattern of the video feed 116 to a frame pattern of the video of an inserted advertisement can indicate advertisement insertion boundaries (e.g., splice point 146). In addition, a frame pattern change from the video feed to the video of the inserted advertisement followed approximately thirty seconds later by another frame pattern change from the video of the inserted advertisement back to the video feed is an additional indication of an inserted advertisement.

In another embodiment, the advertisement tracking service 124 can detect a splice point 146 in the video feed 116 as a timing clock change from the video feed to video of an advertisement 144 that has been inserted into the video feed. Typically, various timing clocks in an MPEG transport stream are sequentially increasing. When a timing clock of the video suddenly changes (e.g., to a previous time, or jumps ahead in time more than would be expected), the timing clock change can be detected as a splice point 146 that indicates where an advertisement has been inserted into the video feed.

In another embodiment, the advertisement tracking service 124 can detect a splice point 146 in the video feed 116 as a change in picture group signaling from the video feed to video of an advertisement 144 that has been inserted into the video feed. A change to the MPEG encoded redundancy that includes groups of pictures (GOPs) composed of I-frames, B-frames, and/or P-frames can be detected as splice point 146 that indicates where an advertisement has been inserted into the video feed.

In another embodiment, the advertisement tracking service 124 can detect a splice point 146 in the video feed 116 as a signature of advertisement insertion equipment that inserts an advertisement 144 into the video feed. A signature of the advertisement insertion equipment can be detected as a vertical and/or horizontal resolution change from the video feed to the video of the inserted advertisement. The resolution change can be detected as splice point 146 that indicates where an advertisement has been inserted into the video feed.

In another embodiment, the advertisement tracking service 124 can detect a splice point 146 in the video feed 116 as a bit rate change from the video feed to video of an advertisement that has been inserted into the video feed. For a channel in the video feed 116, a bit rate can go “flat” where a local advertisement is inserted into the video feed, and the flat bit rate can be detected as a splice point.

In another embodiment, the advertisement tracking service 124 can detect a splice point 146 in the video feed 116 as Extended Data Services (XDS) ancillary data discontinuity from the video feed to video of the advertisement that has been inserted into the video feed. The XDS is a standard by which ancillary data (e.g., metadata, clock data, etc.) can be delivered along with or as part of the video feed 116. A sudden change in the ancillary data, such as a clock change, can be detected as splice point 146 that indicates where an advertisement has been inserted into the video feed.

In another embodiment, the advertisement tracking service 124 can detect a splice point 146 in the video feed 116 as a change in an audio bit rate from the video feed to video of an advertisement that has been inserted into the video feed. A shift in the audio Kbit rate from the video feed 116 to the video for an inserted advertisement can be detected as splice point 146 that indicates where an advertisement has been inserted into the video feed.

In one or more embodiments, the advertisement tracking service 124 at content distributor 102 can be implemented to generate a signature 148 of an advertisement that has been detected or otherwise determined. In an embodiment, the advertisement tracking service 124 can also be implemented to determine a product or service that is advertised in the advertisement, such as from the metadata 120 that is associated with the advertisement. In an embodiment, the advertisement tracking service 124 can also be implemented to generate or otherwise determine an image representation 150 of the advertisement that represents the product or service. The storage media 122 can be utilized to store or otherwise maintain the advertisement signatures 148 and the advertisement image representations 150 that correspond to respective advertisements.

In an embodiment, the advertisement tracking service 124 can generate a corresponding image representation 150 of the advertisement which can include an image of a product shown in the advertisement and/or can include a text label of a product shown in the advertisement. The image representation 150 of an advertisement can be utilized as a poster image that best represents the product or service that is advertised in the advertisement. For example, advertisements may typically include a few seconds of a product displayed at the end of an advertisement for viewer recognition. This product “shot” can be used to develop the image representation of an advertisement.

The advertisement tracking service 124 can generate an advertisement signature 148 of an advertisement 144 based on video and/or coding characteristics of the advertisement. Alternatively, or in addition, the signature 148 of an advertisement 144 can be based on the closed caption data for an advertisement if the data is available for the advertisement. Alternatively, or in addition, the signature 148 of an advertisement 144 can be generated based on a corresponding image representation 150 of the advertisement. Alternatively, the signature for the advertisement can be developed by hand and annotated with an advertisement identifying number or other criteria for the metadata that is associated with the advertisement.

The advertisement tracking service 124 can then detect or otherwise recognize occurrences of the advertisement 144 by the signature 148 when the advertisement is subsequently received via the video feed (e.g., or other video feeds), and/or subsequently broadcast for viewing. The occurrences of the advertisement 144 can then be compared against the data set of advertisement signatures 148 and tracked to compile distribution data corresponding to the advertisement. The distribution data can then be utilized by advertisers to audit the advertisements that have been paid for distribution, and also to determine the mix of national and local advertisement inventories to negotiate advertising rates.

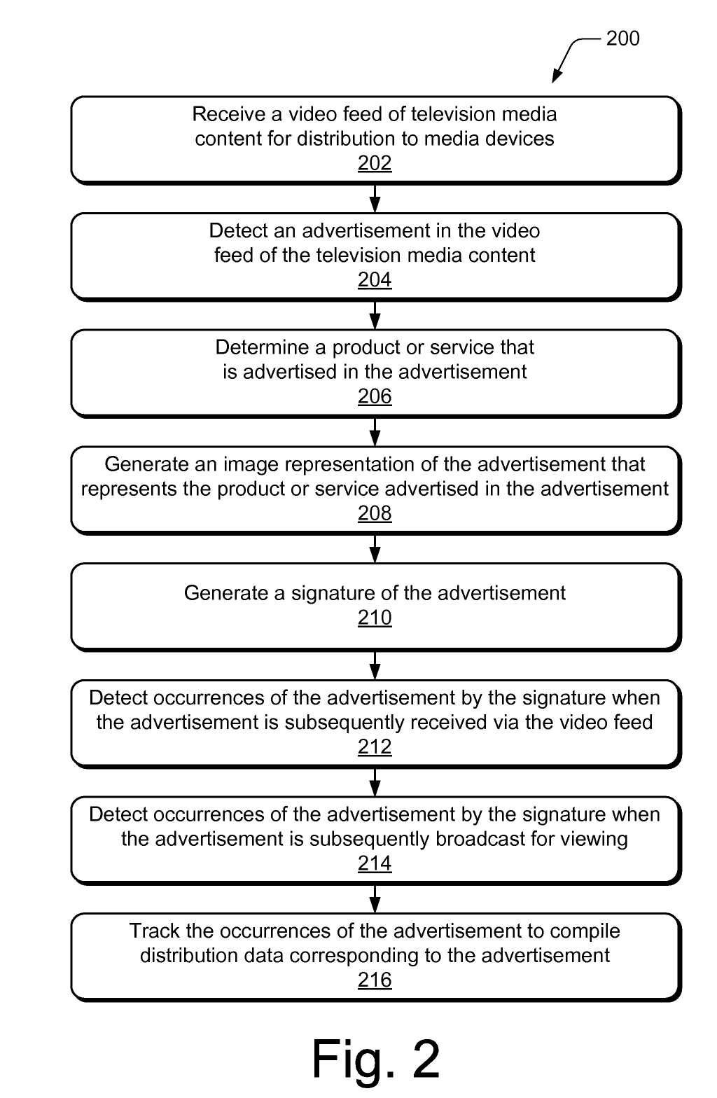

Example method 200 is described with reference to FIG. 2 in accordance with one or more embodiments of advertisement signature tracking. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example method 200 may be described in the general context of computer-executable instructions which can include software, applications, routines, programs, objects, functions, methods, procedures, components, modules, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of advertisement signature tracking. The order in which the method is described is not intended to be construed as a limitation, and any number of the described method blocks can be combined in any order to implement the method, or an alternate method.

At block 202, a video feed of television media content is received for distribution to media devices. For example, a media content server 114 at content distributor 102 (FIG. 1) receives the video feed 116 of television media content that includes advertisements 142 and 144. At block 204, an advertisement in the video feed of the television media content is detected. For example, the advertisement tracking service 124 at content distributor 102 detects or otherwise determines that the video feed 116 includes an advertisement 144. In various embodiments, the advertisement tracking service 124 can detect an advertisement by various techniques, such as determining the boundaries of an advertisement (e.g., a beginning and/or an end of an advertisement), or by detecting a splice point in a video feed or video stream that indicates where an advertisement has been spliced into the video stream.

At block 206, a product or service that is advertised in the advertisement is determined. For example, the advertisement tracking service 124 at content distributor 102 determines a product or service that is advertised in the advertisement 144, such as from the metadata 120 that is associated with the advertisement. At block 208, an image representation of the advertisement is generated that represents the product or service advertised in the advertisement. For example, the advertisement tracking service 124 at content distributor 102 generates an image representation 150 of an advertisement that represents the product or service. The image representation 150 of an advertisement can include an image of a product shown in the advertisement and/or can include a text label of a product shown in the advertisement. In addition, the image representation 150 of an advertisement can be utilized as a poster image that best represents the product or service that is advertised in the advertisement.

At block 210, a signature of the advertisement is generated. For example, the advertisement tracking service 124 at content distributor 102 generates an advertisement signature 148 of an advertisement 144 based on video and/or coding characteristics of the advertisement, based on closed caption data for an advertisement if the data is available, and/or based on a corresponding image representation 150 of the advertisement.

At block 212, occurrences of the advertisement are detected by the signature when the advertisement is subsequently received via the video feed and, alternatively or in addition at block 214, occurrences of the advertisement are detected by the signature when the advertisement is subsequently broadcast for viewing. For example, the advertisement tracking service 124 at content distributor 102 detects or otherwise recognizes occurrences of the advertisement 144 by the signature 148 of the advertisement when the advertisement is subsequently received via the video feed (e.g., or other video feeds), and/or subsequently broadcast for viewing.

At block 216, the occurrences of the advertisement are tracked to compile distribution data corresponding to the advertisement. For example, the advertisement tracking service 124 at content distributor 102 compares the occurrences of an advertisement 144 against the data set of advertisement signatures 148 and tracks the occurrences to compile distribution data corresponding to the advertisement.

FIG. 3 illustrates various components of an example device 300 that can be implemented as any form of a computer, electronic, appliance, and/or media device to implement various embodiments of advertisement signature tracking. For example, device 300 can be implemented as a content distributor, a media content server, or an independent advertisement tracking service as shown in FIG. 1. Device 300 can include one or more media content interfaces 302 via which any type of audio, video, and/or image media content 304 (e.g., television media content) can be received from a media content source and/or distributed to media devices. The media content interfaces 302 can include Internet Protocol (IP) inputs over which streams of media content are received and/or distributed via an IP-based network.

Device 300 further includes one or more communication interfaces 306 that can be implemented as any one or more of a serial and/or parallel interface, a wireless interface, any type of network interface, a modem, and as any other type of communication interface. The communication interfaces 306 provide a connection and/or communication links between device 300 and communication network(s) by which other communication, electronic, and computing devices can communicate data and media content with device 300.

Device 300 can include one or more processors 308 (e.g., any of microprocessors, controllers, and the like) which process various computer-executable instructions to control the operation of device 300 and to implement embodiments of advertisement signature tracking. Alternatively or in addition, device 300 can be implemented with any one or combination of hardware, firmware, or fixed logic circuitry that is implemented in connection with signal processing and control circuits which are generally identified at 310.

Device 300 can also include computer-readable media 312, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 300 may also include a recording media 314 to maintain recorded media content 316 that device 300 receives and/or records (e.g., recorded television content, recorded on-demand media content, or assets).

Computer-readable media 312 provides data storage mechanisms to store media content 304, as well as various device applications 318 and any other types of information and/or data related to operational aspects of device 300. For example, an operating system 320, a device manager 322, and an advertisement tracking service 324 can each be maintained as a computer application and/or software module with the computer-readable media 312 and executed on the processors 308 to implement various embodiments of advertisement signature tracking.

Although not shown, device 300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of advertisement signature tracking have been described in language specific to features and/or methods, it is to be understood that the subject of the appended claims is not necessarily limited to the specific features or methods described. Rather, the specific features and methods are disclosed as example implementations of advertisement signature tracking.

1. A method, comprising:
receiving a video feed of television media content for distribution to media devices, the video feed including advertisements;
detecting an advertisement in the video feed of the television media content;
generating a signature of the advertisement; and
detecting occurrences of the advertisement by the signature when the advertisement is subsequently received via the video feed.

2. A method as recited in claim 1, further comprising detecting the occurrences of the advertisement by the signature when the advertisement is subsequently broadcast for viewing.

3. A method as recited in claim 1, further comprising determining a product or service that is advertised in the advertisement.

4. A method as recited in claim 1, further comprising generating an image representation of the advertisement that represents a product or service advertised in the advertisement.

5. A method as recited in claim 4, wherein the signature of the advertisement is generated based on the image representation of the advertisement.

6. A method as recited in 4, wherein the image representation of the advertisement includes an image of the product shown in the advertisement.

7. A method as recited in 4, wherein the image representation of the advertisement includes a text label of the product shown in the advertisement.

8. A method as recited in claim 1, further comprising tracking the occurrences of the advertisement to compile distribution data corresponding to the advertisement.

9. A content distributor, comprising:
a media content server configured to receive a video feed of television media content for distribution to media devices, the video feed including advertisements;
an advertisement tracking service configured to:
detect an advertisement in the video feed of the television media content;
generate a signature of the advertisement; and
detect occurrences of the advertisement by the signature when the advertisement is subsequently received via the video feed.

10. A content distributor as recited in claim 9, wherein the advertisement tracking service is further configured to detect the occurrences of the advertisement by the signature when the advertisement is subsequently broadcast for viewing.

11. A content distributor as recited in claim 9, wherein the advertisement tracking service is further configured to determine a product or service that is advertised in the advertisement.

12. A content distributor as recited in claim 9, wherein the advertisement tracking service is further configured to generate an image representation of the advertisement that represents a product or service advertised in the advertisement.

13. A content distributor as recited in claim 12, wherein the signature of the advertisement is generated based on the image representation of the advertisement.

14. A content distributor as recited in claim 12, wherein the image representation of the advertisement includes an image of the product shown in the advertisement.

15. A content distributor as recited in claim 12, wherein the image representation of the advertisement includes a text label of the product shown in the advertisement.

16. A content distributor as recited in claim 9, wherein the advertisement tracking service is further configured to track the occurrences of the advertisement to compile distribution data corresponding to the advertisement.

17. One or more computer-readable media comprising computer-executable instructions that, when executed, direct a content distributor to:
receive a video feed of television media content for distribution to media devices, the video feed including advertisements;
detect an advertisement in the video feed of the television media content;
generate a signature of the advertisement; and
detect occurrences of the advertisement by the signature when the advertisement is subsequently received via the video feed.

18. One or more computer-readable media as recited in claim 17, further comprising computer-executable instructions that, when executed, direct the content distributor to generate an image representation of the advertisement that represents a product or service advertised in the advertisement.

19. One or more computer-readable media as recited in claim 18, further comprising computer-executable instructions that, when executed, direct the content distributor to generate the signature of the advertisement based on the image representation of the advertisement.

20. One or more computer-readable media as recited in claim 17, further comprising computer-executable instructions that, when executed, direct the content distributor to track the occurrences of the advertisement to compile distribution data corresponding to the advertisement.
